(19) United States
(12) Patent Application Publication
(10) Pub. No.: US 2015/0046599 A1
(43) Pub. Date: Feb. 12, 2015

(54) MULTICHANNEL COMMUNICATION SYSTEMS AND METHODS OF USING THE SAME

(71) Applicants: Sergey Ulanov, Bellevue, WA (US); Alberto Martin, Kirkland, WA (US); Albert Wong, Seattle, WA (US); Hin Chung Lam, Seattle, WA (US); Gary Kacmarcik, Bothell, WA (US); David Maclachlan, Redmond, WA (US)

(72) Inventors: Sergey Ulanov, Bellevue, WA (US); Alberto Martin, Kirkland, WA (US); Albert Wong, Seattle, WA (US); Hin Chung Lam, Seattle, WA (US); Gary Kacmarcik, Bothell, WA (US); David Maclachlan, Redmond, WA (US)

(73) Assignee: GOOGLE INC., Mountain View, CA (US)

(21) Appl. No.: 13/246,511

(22) Filed: Sep. 27, 2011

(51) Int. Cl. G06F 15/16

(52) U.S. Cl. 709/230

(57) ABSTRACT

In a general aspect, a computer-readable storage medium stores instructions that when executed cause a processor to perform a process. The instructions can include instructions to transmit video data of a remote desktop session to a client via a first data channel using a first protocol. The instructions can also include instructions to transmit event data of the remote desktop session to the client via a second data channel using a second protocol, the second protocol being different than the first protocol.

### TECHNICAL FIELD

This description relates to communication systems that include multiple channels.

### BACKGROUND

A host device may communicate with a client device to provide data to or receive data from the client device. For example, a host device may communicate with a client device during a remote desktop session. In such an example, a client device can be used to interact with an application operating at or by the host device.

Often data of different types may be exchanged between the host device and the client device. For example, multimedia data, such as sounds and video may be provided to the client device. Additionally, event or control data may also be exchanged between the host device and the client device.

In some instances, it may be important that the event or control data be exchanged between the client device and the host device such that no portion of the data, such as individual packets of the data, is missed or not received by the intended recipient (the client device). Also, in some cases, it may be acceptable that some of the multimedia data, such as individual packets of the data, is missed or not received by the intended recipient (the client device).

Thus, a need exists for systems, methods, and apparatus that allow the different types of data to be transmitted between host devices and client devices according to the type of data being transmitted.

### SUMMARY

In a general aspect, a computer-readable storage medium stores instructions that when executed cause a processor to perform a process. The instructions can include instructions to transmit video data of a remote desktop session to a client via a first data channel using a first protocol. The instructions can also include instructions to transmit event data of the remote desktop session to the client via a second data channel using a second protocol, the second protocol being different than the first protocol.

In another general aspect, a system includes a client and a host. The host has a delivery module and a receiving module. The delivery module is configured to provide a first type of data to the client via a first channel and a second type of data to the client via a second channel different than the first channel. The receiving module is configured to receive data from the client via the second channel.

In yet another general aspect, a method includes transmitting video data of a remote desktop session to a client via a first data channel using a first protocol. The method may also include receiving event data of the remote desktop session from the client via a second data channel using a second protocol. The second protocol is different than the first protocol.

The details of one or more implementations are set forth in the accompanying drawings and the description below. Other features will be apparent from the description and drawings, and from the claims.

### BRIEF DESCRIPTION OF THE DRAWINGS

FIG. 1 is a schematic diagram illustrating a system according to an implementation.

FIG. 2 is a schematic diagram of a host device according to an implementation.

FIG. 3 is a schematic diagram of a client device according to an implementation.

FIG. 4 is a flow chart of a method of using a multichannel system according to an implementation.

FIG. 5 is a schematic diagram of a multichannel communication system according to an implementation.

### DETAILED DESCRIPTION

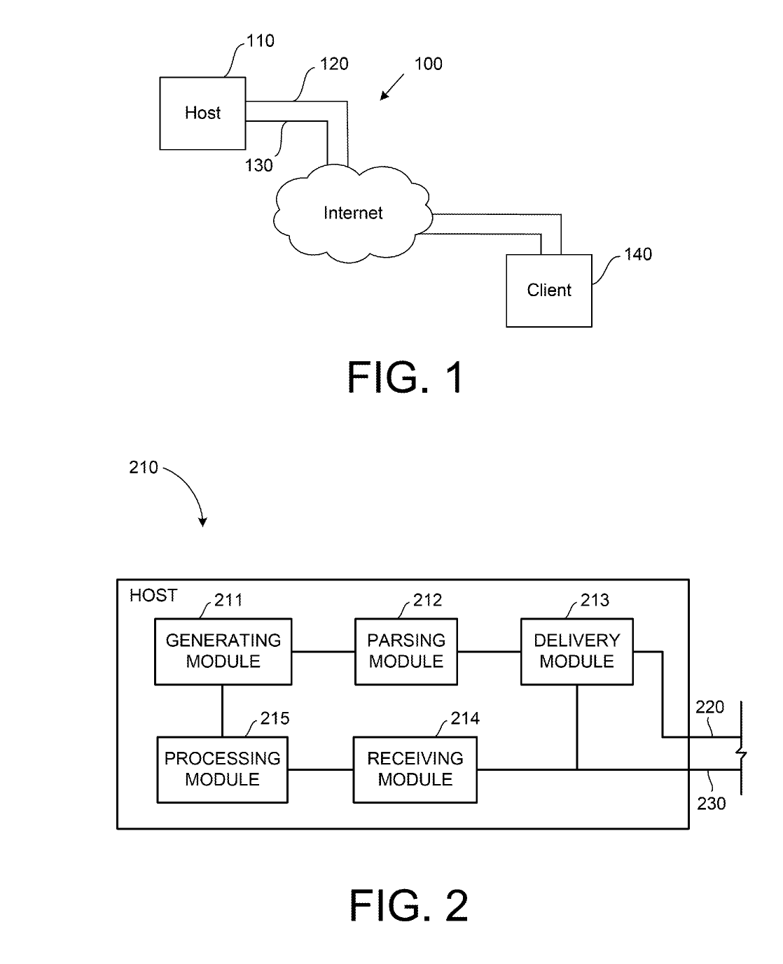

FIG. 1 is a schematic diagram of a system 100 according to an implementation. The system 100 is configured to provide for the communication or exchange of information between two objects, such as two computers or computer systems. In the illustrated implementation, the system 100 includes a host or a host device 110 and a client or a client device 140. The host device 110 and the client device 140 are configured to exchange information. Specifically, the host device 110 is configured to send information to and receive information from the client device 140. The client device 140 is configured to receive information from and send information to the host device 110.

In the illustrated implementation, the system 100 includes a first channel 120 and a second channel 130. In some implementations, a channel is configured to allow data or information to be sent from one location (such as a host) to another location (such as a client). The channel may be a socket with various attributes. The first channel 120 and the second channel 130 are configured to allow information to be exchanged between the host device 110 and the client device 140. Specifically, the first channel 120 and the second channel 130 are configured to allow information such as multimedia information (video and sound information) and event or control data to be exchanged between the host device 110 and the client device 140. In some implementations, the first channel 120 is a channel that is parallel to the second channel 130. In some implementations, the first channel 120 is a channel that is independent from the second channel 130.

The first channel 120 and the second channel 130 each extend from the host device 110 to the client device 140. In the illustrated implementation, the host device 110 and the client device 140 are connected via the channels 120 and 130 over the Internet. In other implementations, the host device 110 and the client device 120 are connected via an intranet (e.g., a local area network (LAN)) or other network system (e.g., a wide area network (WAN)).

In some implementations, the host device 110 is configured to send a first type of data or information to the client device 140 via the first channel 120 and a second type of data or information to the client device 140 via the second channel 130. For example, in some implementations, the host device 110 is configured to identify and parse the data or information of the first type and send it to the client device 140 via the first channel. Additionally, in some implementations, the host device 110 is configured to identify and parse the data or information of the second type and send it to the client device 140 via the second channel.

In some implementations, the first type of information or data is different than the second type of information or data. For example, in some implementations, the first type of information or data is multimedia information or data such as video data, sound data, or other type of audio or visual data. In some implementations, the second type of information or data is control or event data. For example, in some implementations, the second type of information or data is keyboard stroke information, mouse movement information, touchscreen contact information, or authentication or sign-in validation information. In other implementations, the second type of information is another type of control or event data.

In some implementations, the first channel 120 is an unreliable channel and has a shorter latency than the second channel 130. In some implementations, the first channel 120 is a real-time transport protocol (RTP) channel or a user datagram protocol (UDP) channel. In such implementations, the system 100 does not attempt to guarantee or confirm that all data or information sent by host device 110 is received by the client device 140. In other words, a confirmation of receipt of information or data received by the client device 140 is not sent by the client device 140 to the host device 110. In other implementations, the first channel 120 is a channel of another type of lossy (or unreliable) channel. In some implementations, the first channel 120 is a secure real-time transport protocol (SRTP) or an RTP and a datagram transport layer security (DTLS) channel. In other implementations, the first channel 120 is a real-time transport control protocol channel.

In some implementations, the protocols described herein allow for a connection between a client device (such as a local device) and a host device (such as a remote computer). In some implementations, the protocols described herein existing standards, support firewall traversal, support low-latency data transfer, are extendable (new features may be added), are secure, and are compatible with peer-to-peer (P2P) protocols used in HTML5 and Pepper API.

In some implementations, the first channel 120 is a unidirectional channel. In other words, in such implementations, data or information only travels in one direction along the first channel 120 (such as from the host device 110 to the client device 140). In other implementations, the first channel 120 is a bidirectional channel. In other words, the information or data can travel in two directions along the channel 120 (such as from the host device 110 to the client device 140 and from the client device 140 to the host device 110).

In some implementations, the second channel 130 is a reliable or high fidelity channel. For example, in some implementations, the second channel 130 is a transmission control protocol (TCP) channel. For example, the second channel 130 may be a transport layer security over PseudoTCP or a DTLS channel. In other implementations, a different reliable or high fidelity protocol is used. In some implementations, the host device 110 receives a confirmation or acknowledgement of receipt of the data or information from the client device 140. If the client device 140 does not receive a portion of the information or data that is sent by the host device 110 the host device 110 resends the information or data. In such implementations, all of the information or data sent on the second channel 130 is received by the client device 140.

In some implementations, the client device 140 is configured to send information or data to the host device 110 via the second channel 130. In such implementations, the second channel 130 is a bidirectional channel. In other words, information or data may travel in both directions via the second channel 130. In some implementations, event or control data is sent from the client device 140 to the host device 110 via the second channel 130.

In some implementations, the host device 110 is configured to transmit the first type of data or information to a first port of the client device 140 via the first channel 120 and is configured to transmit the second type of data or information to a second port of the client device 140 via the second channel. The first port of the client device 140 is different than the second port of the client device 140.

In some implementations, a third channel between the host device 110 and the client device 140 may be established. In such implementations, the second channel 130 may be used to convey event messages (such as keyboard and mouse events) from the client device 140 to the host device 110. The third channel may be used to convey control messages (such as screen resolution and other setting type information).

In some implementations, the client device 140 is configured to operate as a client (e.g., a thin client) of the host device 110 via, for example, a remote desktop session. As used herein, the term “remote desktop session” can include any technologies and/or protocols in which commands (e.g., input values) issued from a local client are used to control the functionality (e.g., operation) of a host device (e.g., host device 100) including, for example, Windows Remote Desktop™, Citrix™, WebEx™, etc. technologies and/or protocols.

The client device 140 can be used to interact with an application or computer program operating at the host device 110, such as on a processor of the host device 110. The host device 110 can be configured to send to the client device 140 a stream of images (e.g., screen scrapes, screenshots) (also can be referred to as a stream of frames) representing responses to interactions with the application during a remote desktop session. Accordingly, the processing resources of the host device 110 can be used by the client device 140 to operate the application during the remote desktop session.

In some implementations, the stream of images can be screenshots that are updated at the client device 140 as the client device 140 is used (via event or control data produced at the client device 140) to interact with the application or computer program operating at the host device 110. In some implementations, the stream of images or screenshots may be communicated or transmitted from the host device 110 to the client device 140 via the first channel 120. Event or control data of the application or computer program that is operating at the host device 110 may be transmitted to the client device 140 via the second channel 130. Additionally, in some implementations, control or event data or information such as a crash or a potential crash of the host device 110 may be sent from the host device 110 to the client device 140 via the second channel 130. In such implementations, the crash or the evidence of the crash of the host device 110 might be evident via the first channel 120 (the multimedia data) and the use of the second channel 130 to send the event or control data might be necessary to communicate the crash of the host device 110 to the client device 140.

Additionally, other data, such as control or event data indicative of the interaction with the application or computer program product (key strokes, mouse movement, etc.) may be sent from the client device 140 to the host device via the second channel 130.

FIG. 2 is a schematic illustration of a host device 210 according to an implementation. The host device 210 may be a computing device such as a computer or a server. The host device 210 may be operatively coupled to or configured to communicate with a client device. For example, the host device 210 may be coupled to or configured to communicate with a client device via the Internet, an intranet, or other network system. In the illustrated implementation, the host device 210 is configured to communicate with a client device via a first communication channel 220 and a second communication channel 230.

In the illustrated implementation, the host device 210 includes a generating module 211 that is operatively coupled to a parsing module 212 and a delivery module 213. The generating module 211 is configured to generate information or data that is to be communicated or sent to the client device. For example, in some implementations, the generating module 211 may generate information or data that is associated with an application or computer program that is running on or at the host device 210. The information may include multimedia information (such as screen shots or video of a series of screen shots and audio information) and control or event data.

In the illustrated implementation, the host device 110 includes a processing module 215. The processing module 215 is configured to process or run an application or a computer program. In some implementations, the processing module 215 includes a processor or other type of device configured to process code or instructions on computer readable medium. In some implementations, the processing module 215 is configured to provide data or information related to or associated with an application or computer program that is being run by or on the processing module 215.

The generating module 211 is operatively coupled to the parsing module 212. Specifically, the generating module 211 is configured to convey or deliver the information or data that is to be sent to the client device to the parsing module 212. The parsing module 212 is configured to parse or divide the information or data into a plurality of groups. In some implementations, the parsing module 212 is configured to identify and divide the information or data into different categories or groups based on the types of data. Specifically, in some implementations, parse or divide the information or data into two groups or buckets. The parsing module 212 is configured to divide the data or information into multimedia data (including audio and visual information and data) and event or control data. In other implementations, the parsing module 212 is configured to divide the data or information into different categories or into more than two categories.

The parsing module 212 is operatively coupled to the delivery module 213. The parsing module 212 is configured to provide or transmit data or information to the delivery module 213. Specifically, in some implementations, the parsing module 212 is configured to provide the different types of data or information to the delivery module 213. In some implementations, the parsing module 212 is configured to provide the multimedia data and the control or event data to the delivery module 213. In some implementations, the parsing module 212 is configured to identify the different types of data for the delivery module 213.

The delivery module 213 is configured to provide data or information to the first channel 220 and the second channel 230 for distribution to the client device. In some implementations, the delivery module 213 is configured to deliver data or information of a first type (as identified by the parsing module 212) to the client device via the first channel 220. The delivery module 213 may also be configured to deliver data or information of a second type to the client device via the second channel 230.

In some implementations, the parsing module 212 can be configured to identify different types of data or information based on characteristics of packets such as indicators included within the packets, the lengths of the packets, modules from which the packets are received, etc. For example, control or event data can be included in (e.g., included in a payload of) a packet that includes data (e.g., bit values in a header) that can be used by the parsing module 212 to identify the packet as a packet including control or event data. Multimedia data can be included in (e.g., included in a payload of) a packet that includes data (e.g., bit values in a header) in that can be used by the parsing module 212 to identify the packet as a packet including multimedia data.

In some implementations, the first channel 220 is an unreliable channel. In some implementations, the first channel 220 is an RTP channel or a UDP channel. In such implementations, the system does not attempt to guarantee or confirm that all data or information sent by host device 210 is received by the client device. In other words, a confirmation of receipt of information or data received by the client device is not sent by the client device to the host device 210. In other implementations, the first channel 220 is a channel of another type of lossy (or unreliable) channel.

In some implementations, the second channel 230 is a reliable or high fidelity channel. For example, in some implementations, the second channel is a TCP channel. In other implementations, a different reliable or high fidelity protocol is used. In some implementations, the host device 210 receives a confirmation or acknowledgement of receipt of the data or information from the client device. If the client device does not receive a portion of the information or data that is sent by the host device 210 the host device 210 resends the information or data (in response to a request from the client device to resend the information). In such implementations, all of the information or data sent on the second channel 230 is received by the client device (after being resent).

In the illustrated implementation, the host device 210 includes a receiving module 214. The receiving module 214 is configured to receive data or information from the client device. In some implementations, the receiving module 214 is configured to receive event or control data from the client device via the second channel 230. For example, in some implementations, the receiving module 214 is configured to receive event or control data or information from the client device. In some implementations, the event or control data received from the client device is associated with the application or computer program that is being run or processed by the host device 210. For example, the event or control data may be keyboard strokes, mouse movements, etc. input by a user of the client device. In such implementations, such event or control data is conveyed by the receiving module 214 to the processing module 215.

In some implementations, the components or modules of the host device 210 can be, or can include, hardware-based modules (e.g., a digital signal processors (DSP), field programmable gate arrays (FPGA), memories), firmware modules, and/or software-based modules (e.g., modules of computer code, sets of computer-readable instructions that can be executed at a computer). For example, in some implementations, one or more portions of the generating module 211 can be, or can include, a software module configured for execution by at least one processor (not shown). In some implementations, the functionality of the components or modules can be included in different modules and/or components than those shown in FIG. 2. For example, although not shown, the functionality of the generating module 211 can be included in a different module or divided into several different modules.

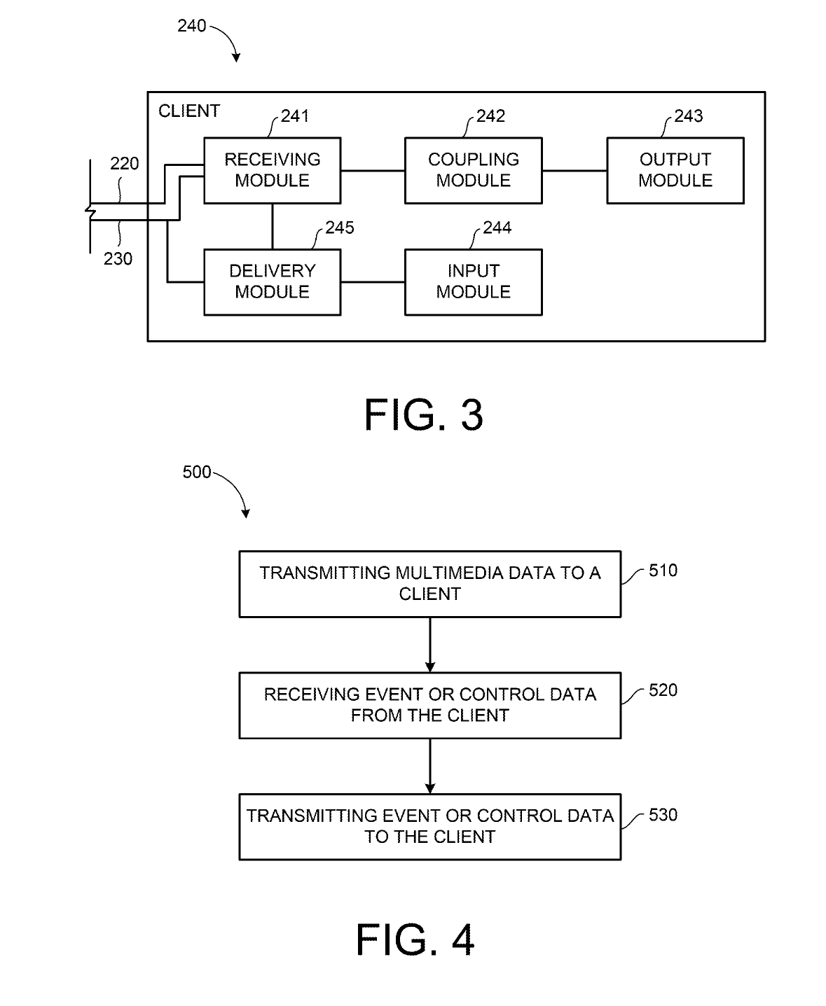

FIG. 3 is a schematic illustration of a client or a client device 240 according to an implementation. The client device 240 is operatively coupled to a host device, such as via the Internet, an intranet, or another networking system. In the illustrated implementation, the client device 240 is operatively coupled to the host device via the first channel 220 and the second channel 230.

In the illustrated implementation, the client device 240 includes a receiving module 214 that is operatively coupled to a coupling module 242 and an output module 243. The receiving module 214 is configured to receive the information or data sent to the client device 240 by the host device. For example, the receiving module 240 is configured to receive the information and data sent to the client device 240 via the first channel 220 and the second channel 230.

The receiving module 214 is configured to convey the data and information received to the coupling module 242. The coupling module 242 is configured to align the different types of data together. For example, if multimedia information or data is to be provided to the user of the client device 240 at the same time, the coupling module 242 couples those items of data or information together.

The coupling module 242 is configured to provide or convey the data and information received from the host device to the output module 243. The output module 243 is configured to display or present the data or information to a user of the client device 240. For example, in some implementations, the output module 243 includes a visual display device, e.g., a cathode ray tube (CRT), a light emitting diode (LED), or liquid crystal display (LCD) monitor, for displaying visual information or data to the user of the client device 240. In other implementations, the output module 243 includes other components that are configured to provide or display the information or data to a user of the client device 240.

In the illustrated implementation, the client device 240 includes an input module 244 and a delivery module 245. The input module 244 is configured to receive an input from a user of the client device 240. In some implementations, the input from the user is event or control data or information. For example, in some implementations, the input module 244 includes a keyboard, a mouse, or a mouse pad. In other implementations, the input module 244 includes another device that is configured to receive input from a user, including acoustic, speech, or tactile input. In some implementations, the input received from the user is associated with the data or information that is being displayed or provided to the user by the client device 240. For example, in some implementations, the input received by the input module 244 is the interaction of the user with the application or computer program that is being executed at the host device.

The input device 244 is configured to provide the data or information to the delivery module 245. The delivery module 245 is configured to provide the data or information to the host device via the second channel 230. In such implementations, the second channel 230 is a bidirectional channel. In other words, data or information may be exchanged between the host device and the client device 240 is both directions (information may be received by the host device and information may be received by the client device via the second channel 230).

In some implementations, the components or modules of the client device 240 can be, or can include, hardware-based modules (e.g., DSPs, FPGAs, memories, firmware modules, and/or software-based modules (e.g., modules of computer code, sets of computer-readable instructions that can be executed at a computer). For example, in some implementations, one or more portions of the coupling module 242 can be, or can include, a software module configured for execution by at least one processor (not shown). In some implementations, the functionality of the components or modules can be included in different modules and/or components than those shown in FIG. 3. For example, although not shown, the functionality of the coupling module 242 can be included in a different module or divided into several different modules.

FIG. 4 is a flow chart of a method 500 according to an implementation. The method 500 may be used to transmit data from a host device to a client device via different transmission channels. For example, in some implementations, the method 500 includes transmitting a first type of data from a host device to a client device via a first data channel. The method may also include transmitting a second type of data from the host device to the client device via a second data channel. In some implementations, the first data type is different than the second data type and the first transmission channel is of a different type than the second transmission channel.

In the illustrated implementation, at 510, multimedia data is transmitted or sent from the host device to the client device. Data or information of a first type, such as multimedia data, may be sent or transmitted from a host device to a client device via an RTP, UDP, or other lossy protocol channel. For example, in some implementations, the multimedia data is transmitted by the delivery module 213 of the host device 210 of FIG. 2.

In the illustrated implementation, at 520, event or control data may be received by the host device from the client device. Data or information of a second type, such as control or event data, may be sent or transmitted from the client device and received by the host device via a TCP or other high fidelity protocol channel. In some implementations, the event or control data is associated with an application or computer program that is running on the host device. In such implementations, the host device is configured to process the event or control data in view of the application or computer program that is running or being executed at the host device. In some implementations, the event or control data may be received by the receiving module 214 of the host device 210 of FIG. 2.

In the illustrated implementation, at 530, event or control data may be sent or transmitted from the host device to the client device. Data or information of the second type, such as control or event data, may be sent or transmitted from the host device to the client device via the TCP or other high fidelity protocol channel. In some implementations, the event or control data may be sent or transmitted by the delivery module 213 of the host device 210 of FIG. 2.

In some implementations, a method of receiving information from a host device and sending information to a host device may be used. For example, in one implementation, information or data (such as information or data of a first type) may be received by a client device from a host device via a first channel. The first channel may be a RTP or UDP channel. Additionally, information or data (such as information or data of a second type) may be received by the client device from the host device via a second channel. The second channel may be a TCP channel. In some implementations, information or data may be sent by the client device to the host device via one of the first two channels or via a third, different channel.

In some implementations, a multichannel communication system allows for network address translation (NAT) traversal. In some implementations, interactive connectivity establishment (ICE) is used to overcome NAT restrictions. In some implementations, ICE is used for P2P in Pepper. ICE may also be used in connection with Jingle or Jingle ICE-UDP to build applications. Jingle is a P2P extension of the XMPP protocol.

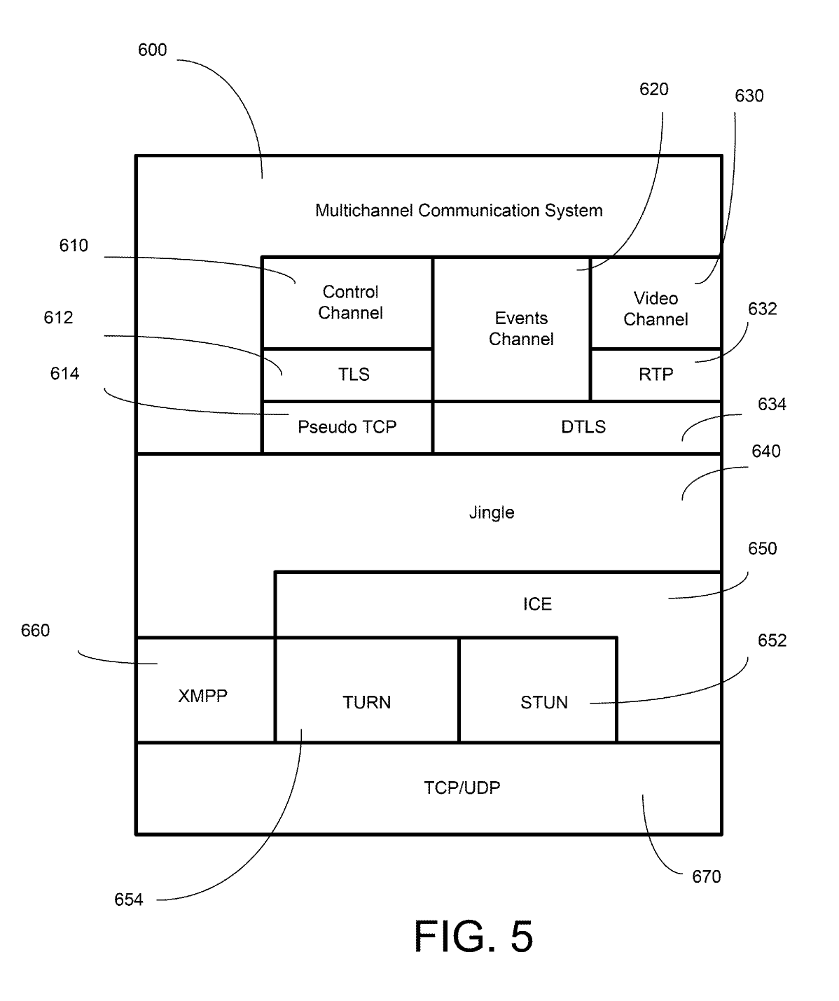

As illustrated in FIG. 5, in some implementations, a multichannel communication system 600 is built on top of many different protocols. Specifically, the multichannel system 600 includes more than one channel. As illustrated in FIG. 5, the multichannel system 600 includes three channels, a control channel 610, an events channel 620, and a video channel 630. In the illustrated implementation, the multichannel communication system 600 is built on top of ICE 650 and Jingle 640. However, in other implementations, ICE 650 and Jingle 640 may be replaced with another networking layer, such as a networking layer that can create a set of P2P channels between a host and a client.

As illustrated in FIG. 5, the multichannel communication system 600 may implement or utilize many different protocols. For example, the multichannel communication system 600 may utilize a transport layer securing (TLS) 612, a Pseudo TCP 614, an RTP 632, a DTLS 634, extensible messaging and presence protocol (XMPP) 660, transversal using relay NAT (TURN) 654, simple traversal of UDP through NATs (STUN) 652, and TCP/UDP 670. In other implementations, other protocols may be used to implement the multichannel communication system 600.

Implementations of the various systems, devices, and techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium), for processing by, or to control the operation of, data processing apparatus, e.g., a programmable processor, a computer, or multiple computers. Thus, a computer-readable storage medium can be configured to store instructions that when executed cause a processor (e.g., a processor at a host device, a processor at a client device) to perform a process. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or subcombinations of the functions, components and/or features of the different implementations described.

1. A non-transitory computer-readable storage medium storing instructions that when executed by a processor cause the processor to perform a process, the instructions comprising instructions configured to:
transmit video data of a remote desktop session to a client via a first data channel using a first protocol, the video data including a series of screenshots from a screen of a computer;
transmit event data of the remote desktop session to the client via a second data channel using a second protocol, the second protocol being different than the first protocol; and
transmit control data of the remote desktop session to the client via a third data channel using the second protocol, the third channel is separate from the second channel, the control data including screen resolution data.

2. The computer-readable storage medium of claim 1, wherein the first data channel using the first protocol has a shorter latency than the data channel using the second protocol.

3. The computer-readable storage medium of claim 1, wherein the second protocol is transmission control protocol and the first protocol is one of real-time transport protocol and user datagram protocol.

4. The computer-readable storage medium of claim 1, wherein the video data is transmitted to a first port of the client and the event data is transmitted via a second port of the client different than the first port of the client.

5. The computer-readable storage medium of claim 1, further comprising instructions to:
receive event data from the client via the data channel.

6. The computer-readable storage medium of claim 1, wherein the first data channel using the first protocol is a unidirectional channel configured to transmit in one and only one direction, and the second data channel using the second protocol is a bidirectional channel, the second protocol is different and a higher fidelity protocol than the first protocol.

7. A system, comprising:
a client computing device; and
a host computing device having a delivery module and a receiving module, the delivery module being configured to provide:
a first type of data related to a series of screenshots from a screen of a computer of a remote desktop session to the client via a first channel,
a second type of data of the remote desktop session to the client via a second channel separate and different than the first channel, the receiving module being configured to receive data from the client via the second channel, and
a third type of data of the remote desktop session to the client via a third channel separate from the first and second channels, the receiving module being configured to receive data from the client via the third channel, the third type of data including at least one of keyboard events and mouse events, the at least one of keyboard events and mouse events being associated with a computer program that is being processed by the host computing device.

8. The system of claim 7, wherein the first type of data is provided to the client via the first channel using a first protocol, the second type of data is provided to the client via the second channel using a second protocol different and a higher fidelity protocol than the first protocol, and the third type of data is provided to the client via the third channel using the second protocol.

9. The system of claim 8, wherein the first type of data is provided to the client via the first channel using one of real-time transport protocol and user datagram protocol, the second type of data is provided to the client via the second channel using transmission control protocol, and the third type of data is provided to the client via the third channel using transmission control protocol.

10. The system of claim 7, wherein the host includes a processing module configured to execute software and to process the data received from the first client.

11. The system of claim 7, wherein the first type of data is video data related to the series of screenshots of the remote desktop session, the second type of data is event data of the remote desktop session related to at least one user input event, and the third type of data is control data of the remote desktop session related to screen resolution.

12. The system of claim 7, wherein the host is a remote host.

13. The system of claim 7, wherein the first channel is a unidirectional channel configured to transmit in one and only one direction using a first protocol, the second channel is a bidirectional channel using a second protocol that is different and a higher fidelity protocol than the first protocol, and the third channel is a unidirectional channel or a bidirectional channel.

14. The system of claim 7, wherein the delivery module is configured to provide the first type of data to the client via a first channel on a first port, and the delivery module is configured to provide the second type of data to the client via a second channel on a second port different than the first port.

15. A computer-implemented method, comprising:
transmitting video data of a remote desktop session to a client via a first data channel using a first protocol, the video data including a series of screenshots from a screen of a computer;
receiving event data of the remote desktop session from the client via a second data channel using a second protocol, the second protocol being different than the first protocol the event data including keyboard events and mouse events; and
receiving control data of the remote desktop session from the client via a third data channel using the second protocol, the third channel is separate from the second channel.

16. The method of claim 15, further comprising:
transmitting event data of the remote desktop session to the client via the second data channel; and
transmitting control data of the remote desktop session to the client via the third data channel.

17. The method of claim 15, wherein:
the control data includes a screen resolution of the screen of the computer.

18. The method of claim 15, wherein the transmitting occurs via a first port and the receiving occurs via a second port different than the first port.

19. The method of claim 15, wherein the second protocol is transmission control protocol and the second protocol is one of real-time transport protocol and user datagram protocol.

20. The method of claim 15, further comprising:
processing the event data in view of a computer application stored and executed remote from the client.

21. The computer-readable storage medium of claim 1, wherein:
the event data includes data related to at least one user input event via the computer,
the first channel is separate and different than each of the second and third channels,
the second channel is separate and different than each of the first and third channels, and
the third channel is separate and different than each of the first and second channels.

22. The system of claim 7, wherein:
the first channel is separate and different than each of the second and third channels,
the second channel is separate and different than each of the first and third channels, and
the third channel is separate and different than each of the first and second channels.

23. The system of claim 22, wherein the first type of data is provided to the client via the first channel using a first protocol, the second type of data is provided to the client via the second channel using a second protocol different than the first protocol, and the third type of data is provided to the client via the third channel using the second protocol.

24. The method of claim 15, wherein the first data channel using the first protocol is a unidirectional channel configured to transmit in one and only one direction, and the second data channel using the second protocol is a bidirectional channel, the second protocol is different and a higher fidelity protocol than the first protocol, and the third data channel using the second protocol is a unidirectional channel or a bidirectional channel.

25. The method of claim 15, wherein:
the first channel is separate and different than each of the second and third channels,
the second channel is separate and different than each of the first and third channels, and
the third channel is separate and different than each of the first and second channels.
